(19) United States
(12) Patent Application Publication
(10) Pub. No.: US 2006/0256643 A1
(43) Pub. Date: Nov. 16, 2006

(54) Vibration mixer for simultaneous analyzer

(75) Inventor: Yi-Lung Lee, Taichung County (TW)

Correspondence Address: BACON & THOMAS, PLLC, 625 SLATERS LANE, FOURTH FLOOR, ALEXANDRIA, VA, 22314, US

(73) Assignee: TERA AUTOTECH CORPORATION, TAICHUNG HSIEN (TW)

(21) Appl. No.: 11/129,341

(22) Filed: May 16, 2005

(51) Int. Cl. B01F 11/00

(52) U.S. Cl. 366/110; 366/208

(57) ABSTRACT

A vibration mixer for use in a simultaneous analyzer includes a carrier for holding solutions or reagents for mixing, a first motion unit for reciprocating the carrier in a first direction, and a second motion unit for reciprocating the carrier in a second direction perpendicular to the first direction. The first and second motion units each have two parallel rails, a sliding device coupled to and movable along the rails, and a drive coupled to the sliding device and controllable to reciprocate the sliding device in the first or second direction.

### BACKGROUND OF THE INVENTION

1. Field of the Invention

The present invention relates generally to a simultaneous analyzer and more specifically, to a vibration mixer for simultaneous analyzer.

2. Description of the Related Art

When wishing to mix different solutions or reagents in a laboratory for analysis in a simultaneous analyzer, the solutions or reagents are poured in different wells in a container, and then the container is set in the simultaneous analyzer and vibrated by the simultaneous analyzer through a vibration procedure. According to conventional simultaneous analyzers, the vibration procedure is to reciprocate the container 1 in one direction as shown in FIG. 1 or FIG. 2. This vibration procedure cannot mix every solution or reagent well within a short time.

### SUMMARY OF THE INVENTION

The present invention has been accomplished under the circumstances in view. It is one object of the present invention to provide a vibration mixer for simultaneous analyzer, which can be vibrated on a plane in different directions to achieve a mixing operation.

It is another object of the present invention to provide a vibrating mixer for simultaneous analyzer, which accelerates the mixing work to facilitate analysis.

To achieve these objects of the present invention, the vibration mixer comprises a first motion unit, a second motion unit, and a carrier. The first motion unit comprises a first rail and a second rail arranged in parallel and extending in a first direction, a sliding device coupled to and movable along the first rail and second rail of the first motion unit, and a drive coupled to the sliding device of the first motion unit and adapted to reciprocate the sliding device of first motion unit in the first direction. The second motion unit comprises a first rail and a second rail arranged in parallel and extending in a second direction perpendicular to the first direction and defining with the first and second rail of the first motion unit a motion zone, a sliding device coupled to and movable along the first rail and second rail of the second motion unit, and a drive coupled to the sliding device of the second motion unit and adapted to reciprocate the sliding device of the second motion unit in the second direction perpendicular to the first direction. The carrier is coupled to the sliding device of the first motion unit and the sliding device of the second motion unit and movable by the first motion unit and the second motion unit on a plane within the motion zone.

### BRIEF DESCRIPTION OF THE DRAWINGS

FIG. 1 is schematic drawing showing the vibration direction of a simultaneous analyzer according to the prior art.

FIG. 2 is a schematic drawing showing the vibration direction of another structure of simultaneous analyzer according to the prior art.

FIG. 3 is a top view of a vibration mixer for simultaneous analyzer according to the present invention.

FIG. 4 is a schematic drawing showing a first vibration direction of the vibration mixer according to the present invention.

FIG. 5 corresponds to FIG. 4, showing the carrier shifted to a predetermined NE (North East) location.

FIG. 6 corresponds to FIG. 4, showing the carrier shifted to a predetermined SW (South West) location.

FIG. 7 is a schematic drawing showing a second vibration direction of the vibration mixer according to the present invention.

FIG. 8 corresponds to FIG. 7, showing the carrier shifted to a predetermined NW (North West) location.

FIG. 9 corresponds to FIG. 7, showing the carrier shifted to a predetermined SE (South East) location.

FIG. 10 is a schematic drawing showing a third vibration direction of the vibration mixer according to the present invention.

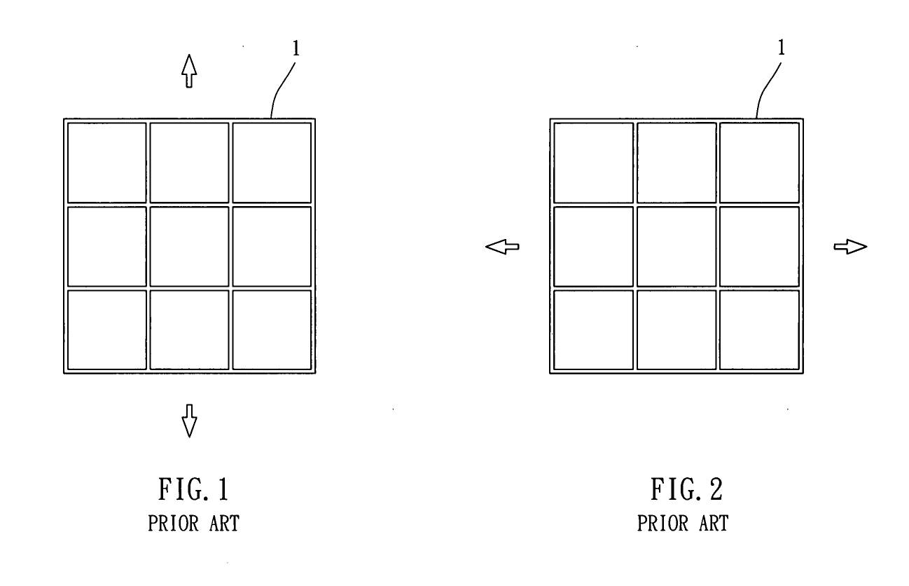

### DETAILED DESCRIPTION OF THE INVENTION

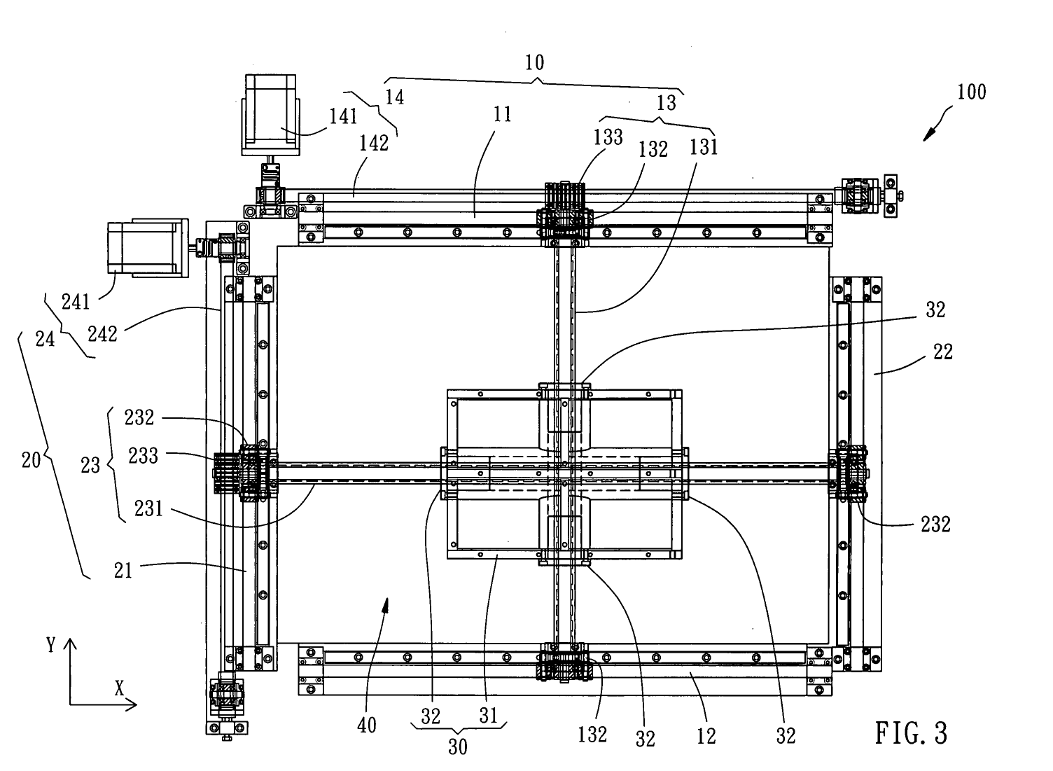

Referring to FIG. 3, a vibration mixer 100 is shown for use in a simultaneous analyzer, comprising a first motion unit 10, a second motion unit 20, and a carrier 30.

The first motion unit 10 comprises a first rail 11, a second rail 12, a sliding device 13, and a drive 14.

The first rail 11 and the second rail 12 are arranged in parallel on a platform (not shown), and spaced from each other at a predetermined distance. The sliding device 13 comprises a link 131, two connectors 132, and a driven member 133. The link 131 is coupled to the first rail 11 and the second rail 12 and extending in direction perpendicular to the extending direction of the rails 11, 12, having two distal ends respectively extending over the rails 11, 12. The two connectors 132 are respectively fixedly fastened to the two ends of the link 131 and respectively movable on the first rail 11 and the second rail 12 to hold the link 131 between the rails 11, 12, for enabling the link 131 to be reciprocated by an external force along the rails 11, 12 in a first direction, namely, the X-axis direction. The driven member 133 according to this embodiment is a gear. The drive 14 comprises a motor 141 and a transmission rod 142. The transmission rod 142 according to this embodiment is a screw rod disposed at an outer side relative to the first rail 11 in a parallel manner and meshed with the driven member 133. The motor 141 is a servo-motor, having a pinion (not shown) fixedly mounted on the output shaft thereof and meshed with the transmission rod 142. Upon operation of the motor 141, the transmission rod 142 is rotated to move the driven member 133, thereby causing the sliding device 13 to be moved along the rails 11, 12. By means of controlling forward/backward rotation of the motor 141, the sliding device 13 is driven to move leftwards or rightwards in X-axis direction (see FIG. 3).

The second motion unit 20 comprises a first rail 21, a second rail 22, a sliding device 23, and a drive 24.

The first rail 21 and the second rail 22 are arranged in parallel on the platform in which the first motion unit 10 is installed, and spaced from each other at a predetermined distance. Further, the rails 21, 22 of the second motion unit 20 and the rails 11, 12 of the first motion unit 10 are arranged at right angles, defining a motion zone 40 (see FIG. 3). The sliding device 23 comprises a link 231, two connectors 232, and a driven member 233. The link 131 is coupled to the first rail 21 and the second rail 22 and extending in direction perpendicular to the extending direction of the rails 21, 22, having two distal ends respectively extending over the rails 21, 22. The two connectors 232 are respectively fixedly fastened to the two ends of the link 231 and respectively movable on the first rail 21 and the second rail 22 to hold the link 231 between the rails 21, 22, for enabling the link 231 to be reciprocated by an external force along the rails 21, 22 in a second direction, namely, the Y-axis direction. The driven member 233 according to this embodiment is a gear. The drive 24 comprises a motor 241 and a transmission rod 242. The transmission rod 242 according to this embodiment is a screw rod disposed at an outer side relative to the first rail 21 in a parallel manner and meshed with the driven member 233. The motor 241 is a servo-motor, having a pinion (not shown) fixedly mounted on the output shaft thereof and meshed with the transmission rod 242. Upon operation of the motor 241, the transmission rod 242 is rotated to move the driven member 233, thereby causing the sliding device 23 to be moved along the rails 21, 22. By means of controlling forward/backward rotation of the motor 241, the sliding device 23 is driven to move forwards or backwards in Y-axis direction (see FIG. 3).

The carrier 30 is adapted to carry a multi-well container for holding different solutions or reagents for mixing, comprising a flat rectangular carrier base 31 and four sleeves 32 respectively provided at the four sides of the flat rectangular carrier base 31. The four sleeves 32 are arranged in two pairs respectively sleeved onto the links 131, 231 such that the links 131, 231 can move the carrier 30 within the aforesaid motion zone 40.

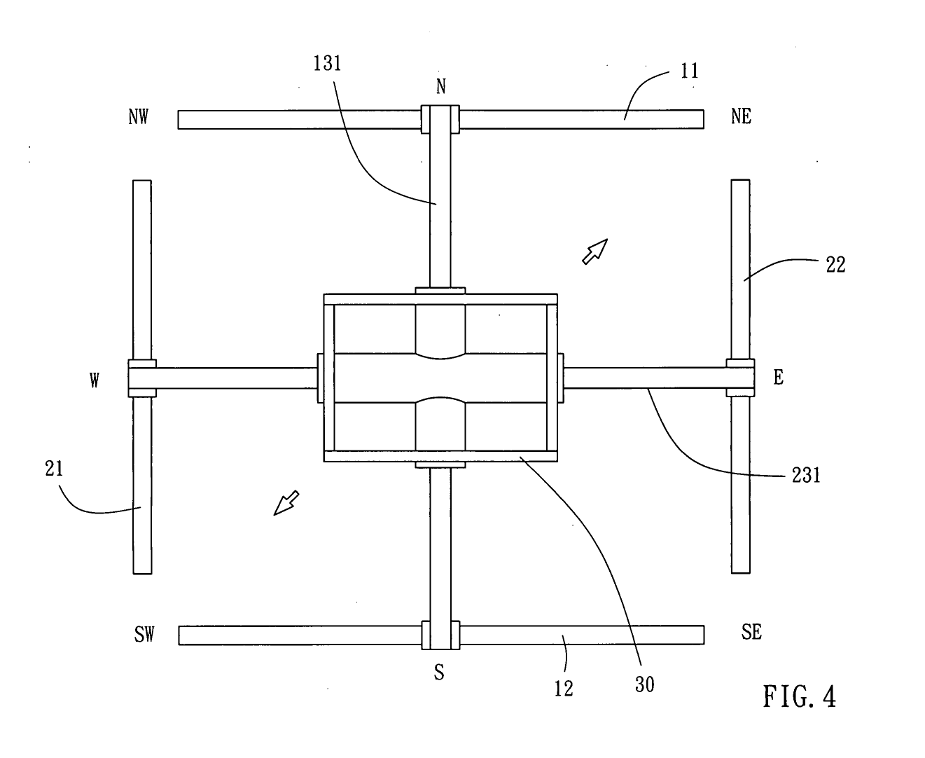

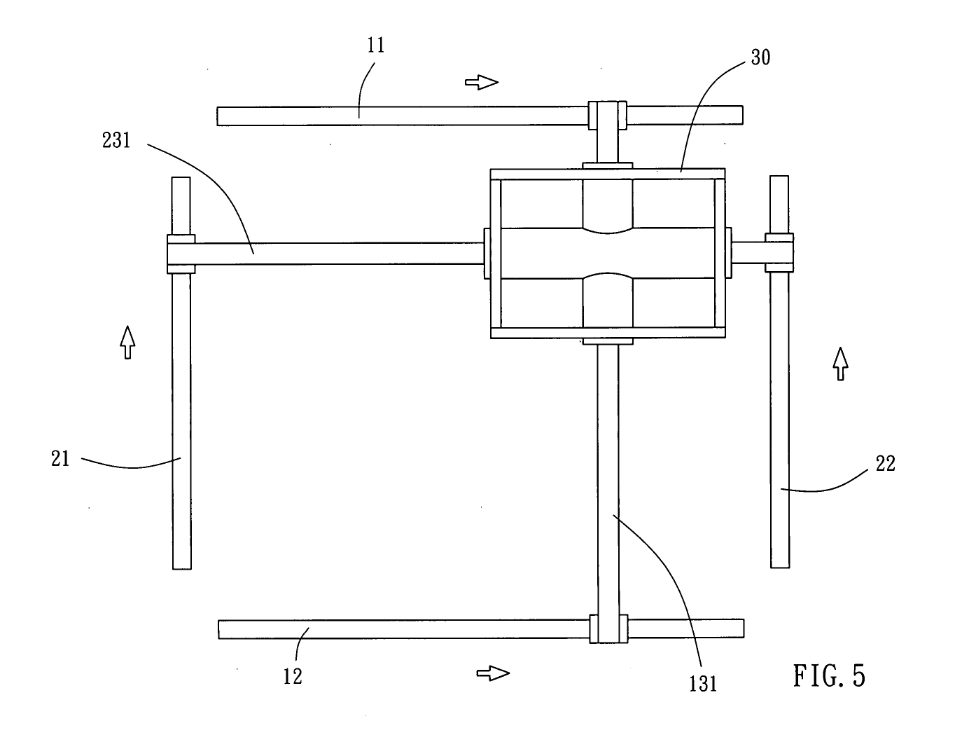

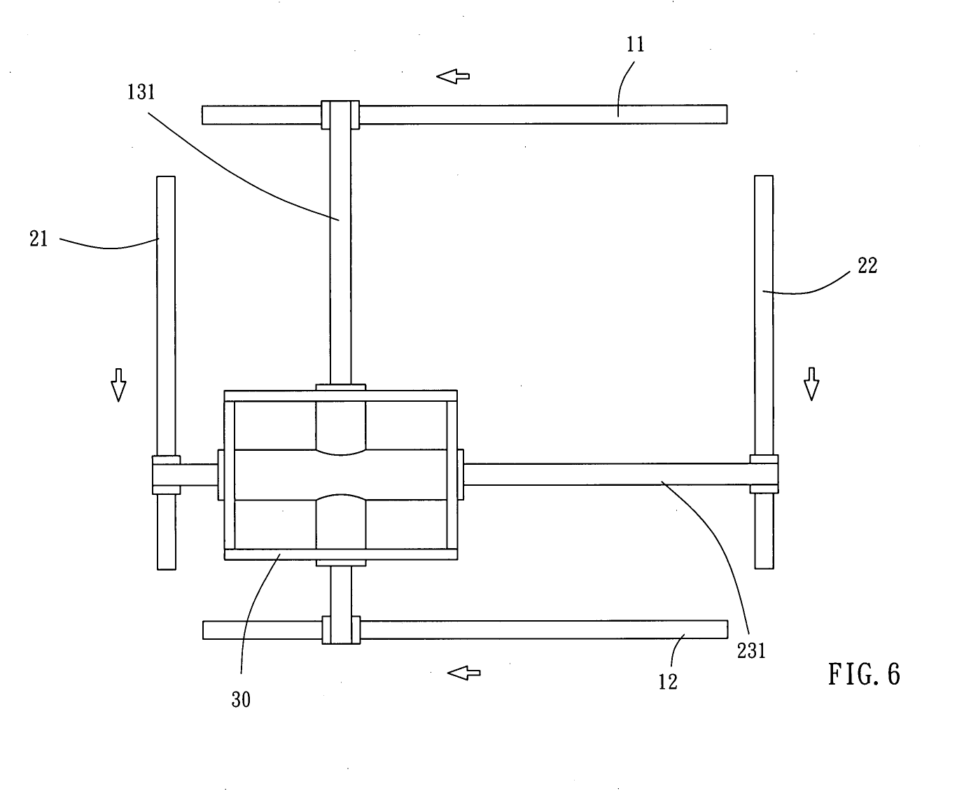

The operation of the vibration mixer 100 will be described hereinafter. At first, the container that holds prepared solutions or reagents is fastened to the carrier 30. When wishing to reciprocate the carrier 30 in NE-SW (North East-South West) direction as shown in FIG. 4, operate the drive 14 of the first motion unit 10 to move the driven member 133, causing the link 131 of the first motion unit 10 to move toward the right side (East), at the same time, operate the drive 24 of the second motion unit 20 to move the driven member 233, causing the link 231 of the second motion unit 20 to move toward the back side (North), and therefore the carrier 30 is moved by the links 131, 231 to a predetermined NE (North East) location (see FIG. 5). After the carrier 30 has been moved to the predetermined NE (North East) location, the drive 14 of the first motion unit 10 and the drive 24 of the second motion unit 20 are reversed, thereby causing the drive 14 of the first motion unit 10 to carry the respective sliding device 13 toward the left side (West) and the drive 24 of the second motion unit 20 to carry the respective sliding device 23 toward the front side (South), and therefore the carrier 30 is moved by the links 131, 231 to a predetermined SW (South West) location (see FIG. 6). By means of repeating the aforesaid action, the carrier 30 is reciprocated in NE-SW (North East-South West) direction as shown in FIG. 4, and the container in moved to and fro with the carrier 30, causing the contained solutions or reagents to be respectively well mixed.

Of course, the objective of the invention is to let the carrier 30 be moved in the motion zone 40 within any of the four quadrants (on the same plane). In addition to the aforesaid reciprocating motion, the carrier 30 can be reciprocated in another way.

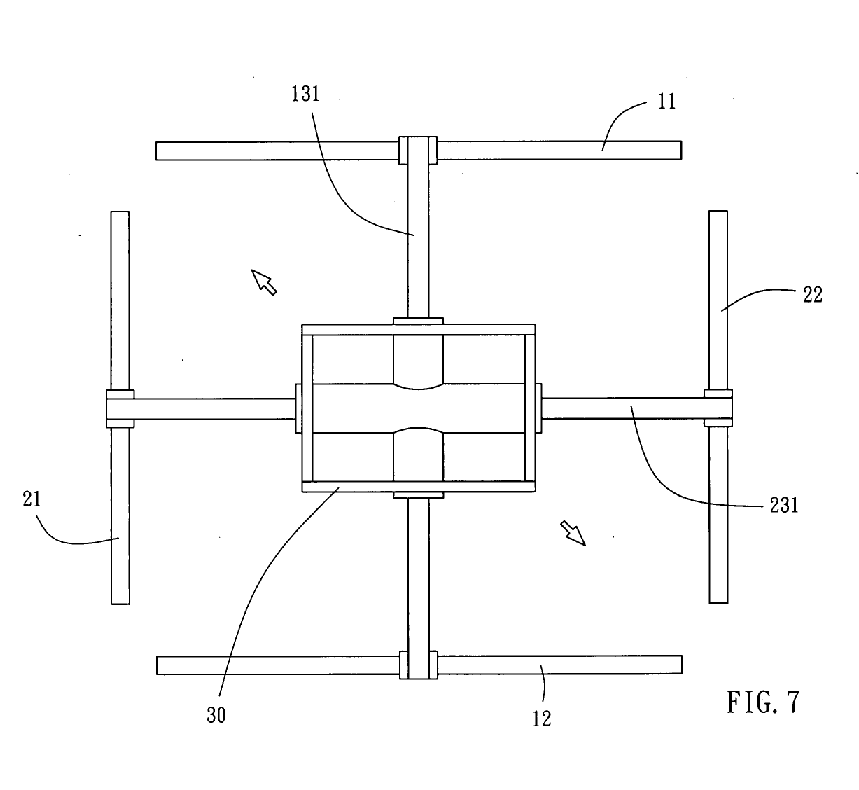

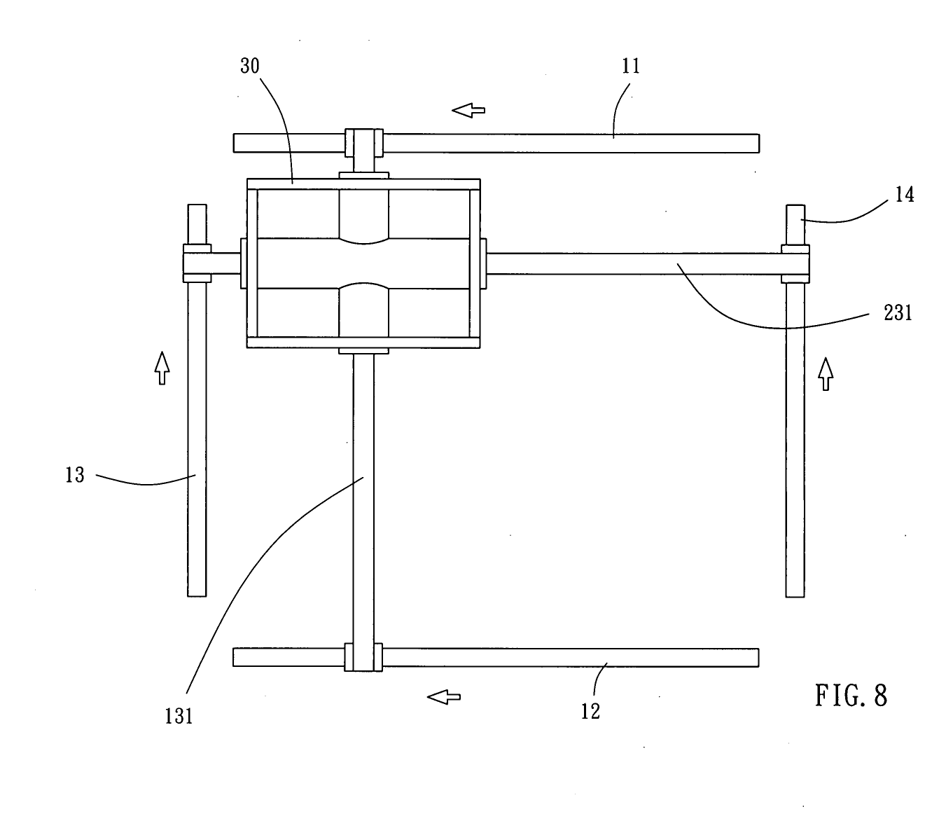

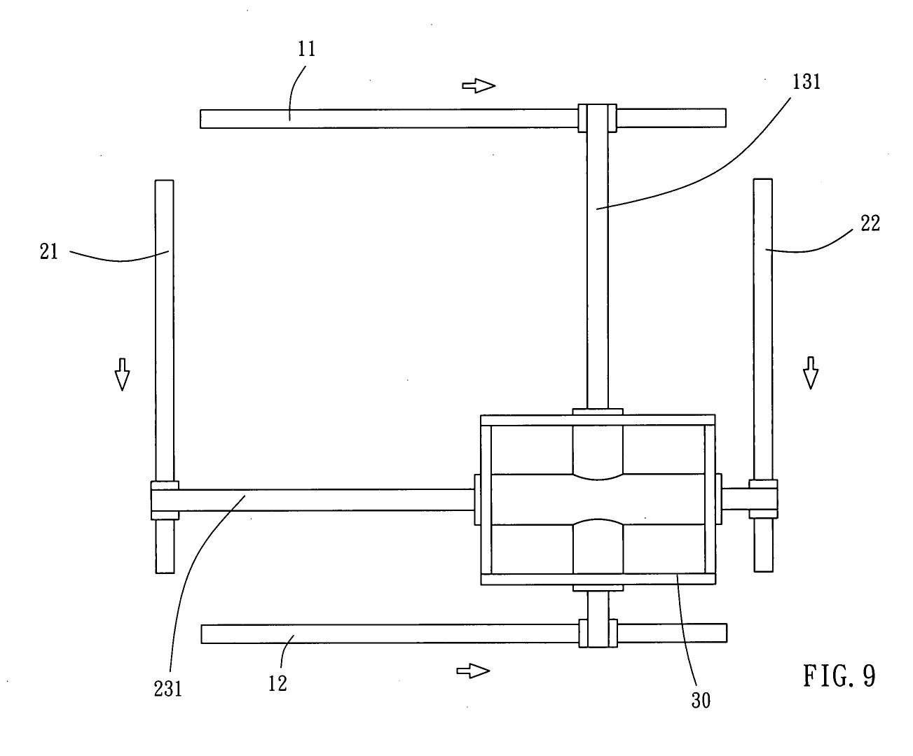

When wishing to reciprocate the carrier 30 in NW-SE (North West-South East) direction as shown in FIG. 7, operate the drive 14 of the first motion unit 10 to move the driven member 133, causing the link 131 of the first motion unit 10 to move toward the left side (West), at the same time, operate the drive 24 of the second motion unit 20 to move the driven member 233, causing the link 231 of the second motion unit 20 to move toward the back side (North), and therefore the carrier 30 is moved by the links 131, 231 to a predetermined NW (North West) location (see FIG. 8). After the carrier 30 has been moved to the predetermined NW (North West) location, the drive 14 of the first motion unit 10 and the drive 24 of the second motion unit 20 are reversed, thereby causing the drive 14 of the first motion unit 10 to carry the respective sliding device 13 toward the right side (East) and the drive 24 of the second motion unit 20 to carry the respective sliding device 23 toward the front side (South), and therefore the carrier 30 is moved by the links 131, 231 to a predetermined SE (South East) location (see FIG. 9). By means of repeating the aforesaid action, the carrier 30 is reciprocated in NW-SE (North West-South East) direction as shown in FIG. 9, and the container in moved to and fro with the carrier 30, causing the contained solutions or reagents to be respectively well mixed.

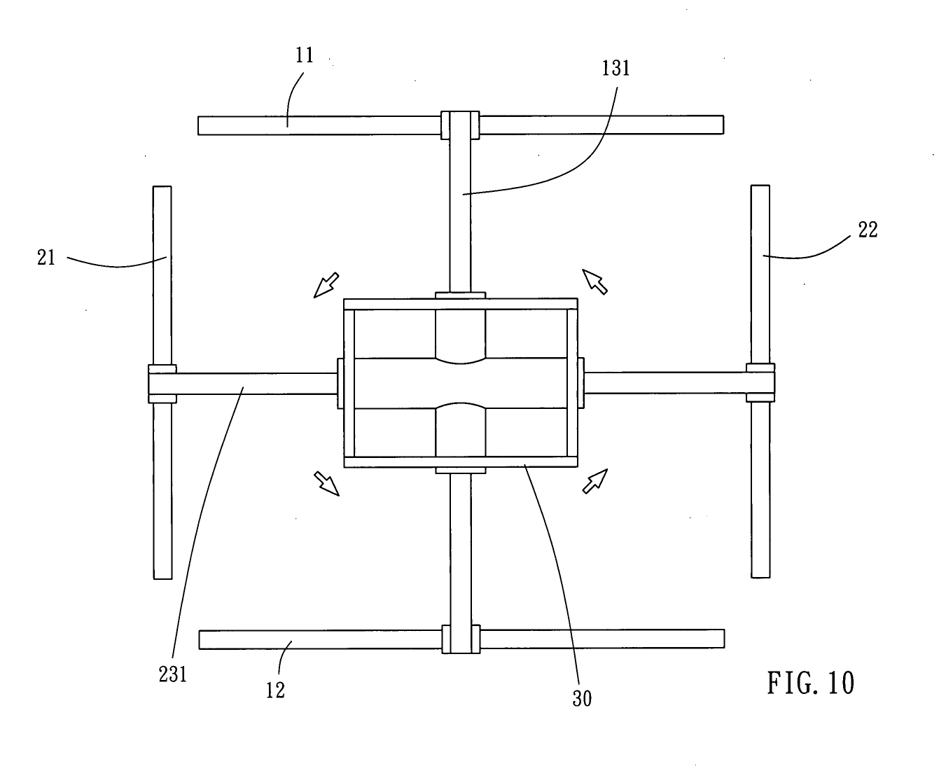

According to the aforesaid embodiment, the carrier 30 is reciprocated linearly. In actual practice, the first and second drives 14, 24 can be intermittently shifted between forward rotation and backward rotation, causing the carrier 30 to be alternatively turned clockwise and counter-clockwise as shown in FIG. 10. Alternatively, the first and second drives 14, 24 can be controlled to rotate the carrier 30 in clockwise direction for a predetermined length of time and then in counter-clockwise direction for a same length of time, causing the contained solutions or reagents to be respectively well mixed.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A vibration mixer for use in a simultaneous analyzer, comprising:
a first motion unit having a first rail and a second rail arranged in parallel and extending in a first direction, a sliding device coupled to and movable along the first rail and second rail of said first motion unit, and a drive coupled to the sliding device of said first motion unit for reciprocating the sliding device of said first motion unit in said first direction;
a second motion unit having a first rail and a second rail arranged in parallel and extending in a second direction perpendicular to said first direction and defining with the first and second rail of said first motion unit a motion zone, a sliding device coupled to and movable along the first rail and second rail of said second motion unit, and a drive coupled to the sliding device of said second motion unit for reciprocating the sliding device of said second motion unit in said second direction perpendicular to said first direction; and
a carrier coupled to the sliding device of said first motion unit and the sliding device of said second motion unit and movable by said first motion unit and said second motion unit on a plane within said motion zone.

2. The vibration mixer as claimed in claim 1, wherein the sliding device of said first motion unit comprises a link connected to said carrier and coupled to the first rail and second rail of said first motion unit and extending in direction perpendicular to the extending direction of the rails of said first motion unit, the link of said first motion unit having two distal ends thereof respectively extending over the rails of said first motion unit, two connectors respectively fixedly fastened to the two ends of the link of said first motion unit and respectively being movable on the first rail and second rail of said first motion unit to hold the link of said first motion unit between the first rail and second rail of said first motion unit and for enabling the link of said first motion unit to be reciprocated along the rails of said first motion unit, and a driven member coupled to the drive of said first motion unit and movable by the drive of said first motion unit to drive the link of said first motion unit to move said carrier.

3. The vibration mixer as claimed in claim 1, wherein the sliding device of said second motion unit comprises a link connected to said carrier and coupled to the first rail and second rail of said second motion unit and extending in direction perpendicular to the extending direction of the rails of said second motion unit, the link of said second motion unit having two distal ends thereof respectively extending over the rails of said second motion unit, two connectors respectively fixedly fastened to the two ends of the link of said second motion unit and respectively being movable on the first rail and second rail of said second motion unit to hold the link of said second motion unit between the first rail and second rail of said second motion unit and for enabling the link of said second motion unit to be reciprocated along the rails of said second motion unit, and a driven member coupled to the drive of said second motion unit and movable by the drive of said second motion unit to drive the link of said second motion unit to move said carrier.

4. The vibration mixer as claimed in claim 1, wherein the drive of said first motion unit comprises a transmission rod disposed at an outer side relative to the first rail of said first motion unit in a parallel manner and meshed with the driven member of said first motion unit, and a motor coupled to the transmission rod of said first motion unit and adapted to rotate the transmission rod of said first motion unit and to further move the sliding device of said first motion unit along the first rail and second rail of said first motion unit.

5. The vibration mixer as claimed in claim 1, wherein the drive of said second motion unit comprises a transmission rod disposed at an outer side relative to the first rail of said second motion unit in a parallel manner and meshed with the driven member of said second motion unit, and a motor coupled to the transmission rod of said second motion unit and adapted to rotate the transmission rod of said second motion unit and to further move the sliding device of said second motion unit along the first rail and second rail of said second motion unit.

6. The vibration mixer as claimed in claim 1, wherein said carrier is adapted to carry a multi-well container for holding different solutions or reagents for mixing.

7. The vibration mixer as claimed in claim 1, wherein said carrier comprises a flat rectangular carrier base and four sleeves respectively provided at four sides of said flat rectangular carrier base, said four sleeves being arranged in two pairs respectively sleeved onto the sliding device of said first motion unit and the sliding device of said second motion unit for enabling said carrier to be moved by said first motion unit and said second motion unit within said motion zone.
